(19) United States
(12) Patent Application Publication
(10) Pub. No.: US 2026/0239002 A1
(43) Pub. Date: Aug. 13, 2026

(54) METHOD AND SYSTEM FOR FACILITATING POST QUANTUM SECURE PRIMARY AUTHENTICATION OF A SUBSCRIBER

(71) Applicant: Samsung Electronics Co., Ltd., Suwon-si, Gyeonggi-do (KR)

(72) Inventors: Dixit KUMAR, Bangalore (IN); Ramesh Chandra VUPPALA, Bangalore (IN); Neha SHARMA, Bangalore (IN); Anshuman NIGAM, Bangalore (IN); Donghyun JE, Suwon-si (KR); Dongmyoung KIM, Suwon-si (KR)

(21) Appl. No.: 19/148,871

(22) PCT Filed: Jan. 16, 2024
(86) PCT No.: PCT/KR2024/000784

§ 371 Date: Jul. 17, 2025

(30) Foreign Application Priority Data
Jan. 17, 2023 (IN) 202341003353
Dec. 18, 2023 (IN) 2023 41003353

(51) Int. Cl. H04W 12/06; H04L 9/08; H04L 9/32; H04W 12/041

(52) U.S. Cl. CPC H04W 12/06; H04L 9/0852; H04L 9/3242; H04W 12/041; H04L 2209/80

(57) ABSTRACT

The present disclosure relates to a 5G communication system or a 6G communication system for supporting higher data rates beyond a 4G communication system such as long term evolution (LTE). The present disclosure relates to a method and system for facilitating post quantum secure primary authentication of a subscriber. The method by an UE discloses applying a quantum safe cryptographic technique on a quantum based public key associated with a home network, generating an encrypted quantum safe shared key based on the applied quantum safe cryptographic technique, transmitting the encrypted quantum safe shared key along with cipher-text value and MAC-tag value associated with the subscriber to a network entity for authenticating the subscriber.

### CROSS-REFERENCE TO RELATED APPLICATION(S)

This application is a U.S. National Stage application under 35 U.S.C. § 371 of an International application number PCT/KR2024/000784, filed on Jan. 16, 2024, which is based on and claims priority of an Indian patent application number 202341003353, filed on Jan. 17, 2023, in the Indian Patent Office, and of an Indian patent application number 202341003353, filed on Dec. 18, 2023, in the Indian Patent Office, the disclosure of each of which is incorporated by reference herein in its entirety.

### TECHNICAL FIELD

The present disclosure relates generally to wireless communication technologies. Particularly, but not exclusively, the present disclosure relates to a method and system for facilitating a secure primary authentication of a subscriber.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

In recent years, several broadband wireless technologies have been developed in order to meet growing number of broadband subscribers for providing better applications and services. For example, a Second Generation (2G) wireless communication system was developed to provide voice services while ensuring the mobility of users. Similarly, a Third Generation (3G) wireless communication was developed to support voice services as well as data services. Further, a Fourth Generation (4G) wireless communication system has been developed to provide high-speed data service. However, the 4G wireless communication system suffers from lack of resources to meet the growing demand for high-speed data services. This problem is solved by Fifth Generation (5G) wireless communication system, which provides ultra-reliability and supports low latency applications.

In sixth generation system (6G) Quantum computer or machines will be widely used which can become threat for current wireless security system. A quantum computer is a computer, which makes use of quantum-mechanical effects. These effects include superposition, which allow quantum bits (qubits) to exist in a combination of several states at once, and entanglement, which further allows connections between separate quantum systems such that they cannot be described independently.

There exist quantum algorithms that use these effects to solve certain cryptographic problems more efficiently than they could be solved on a classical computer. Shor's quantum algorithm for integer factorization runs in polynomial time on a quantum computer. A variant of Shor's algorithm enables a quantum computer to calculate discrete logarithms in polynomial time, both over finite fields and elliptic curves. This variant render several other public-key cryptosystems insecure, including Diffie-Hellman (DH) and Elliptic Curve Diffie-Hellman (ECDH). To counter the threat of quantum computing to asymmetric cryptography it is necessary to swap existing algorithms for new, quantum-resistant algorithms also called as Post Quantum Cryptography (PQC) algorithms. Hence, there is a need for wireless communication networks including beyond Fifth Generation (5G), Sixth Generation (6G), to adapt to these PQC algorithms for enhanced security.

As per TS 33.501 the purpose of the primary authentication and key agreement procedures is to enable mutual authentication between the UE and the network and provide key that can be used between the UE and the serving network in subsequent security procedures. The primary authentication may be referred as UE initially registering to the network or when the UE connecting to a new network from the existing network (roaming scenarios). The serving network shall authenticate a Subscription Permanent Identifier (SUPI) in the process of authentication and key agreement between UE and network. SUPI is a unique identifier associated with a subscriber in a 5G network. It serves as a long-term identifier for a user and is provisioned in the Subscriber Profile Repository (SPR) during the subscription process. Once service network authenticates user's identity, it configures various parameters, services for the respective UE.

In the 5G system, the globally unique 5G subscription permanent identifier is called SUPI as defined in 3GPP TS 23.501. The SUCI is a privacy preserving identifier containing the concealed SUPI. The SUPI is privacy protected over-the-air by using the Subscription Concealed Identifier (SUCI). The Subscription Concealed Identifier, called SUCI, is a privacy preserving identifier containing the concealed SUPI. The UE shall generate a SUCI using a protection scheme with the raw public key, i.e. the Home Network Public Key, that was securely provisioned in control of the home network (HN).

The process of SUCI encryption and decryption is known as SUCI concealment and de-concealment. In 5G, Subscription Identifier, SUCI is shared to HN from UE during the events like during UE initial registration to the network, during UE deregistration request to the network, and during identity request from the network. However, the SUPI encryption and decryption is utmost important as it is related with user privacy details and are prone to IMSI impersonation attacks. In other words, the communication between UE and Network like Primary authentication is not secure against threat possess by introduction of quantum machine, hence our proposed solution targets to address the problem by bringing PQC based quantum safe methods for UE and Network primary authentications.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE

### Technical Solution

One or more shortcomings of the conventional systems are overcome by system and method as claimed and additional advantages are provided through the provision of system and method as claimed in the present disclosure. Additional features and advantages are realized through the techniques of the present disclosure. Other embodiments and aspects of the disclosure are described in detail herein and are considered a part of the claimed disclosure.

In an embodiment, the present disclosure relates to method and system for facilitating post quantum secure primary authentication of a subscriber. The present disclosure discloses a method for facilitating secure primary authentication of a subscriber. The method comprises applying a quantum safe cryptographic technique on a quantum based public key associated with a home network. Further, the method discloses generating a quantum safe shared key and an encrypted quantum safe shared key based on the applied quantum safe cryptographic technique. Finally, the method comprises transmitting the encrypted quantum safe shared key along with cipher-text value and MAC-tag value associated with the subscriber to a network entity for authenticating the subscriber.

In another non-limiting embodiment of the present disclosure, the quantum safe cryptographic technique comprises at least one of post-quantum cryptography (PQC) technique or Quantum key distribution (QKD) technique.

In another non-limiting embodiment of the present disclosure, a quantum safe shared key is used for concealing the subscribers identify while initiating the primary authentication of the subscriber.

In another non-limiting embodiment of the present disclosure, the quantum based public key is received by the UE from the home network.

In another non-limiting embodiment of the present disclosure discloses a method of performing secure primary authentication of a subscriber. The method comprises receiving, by a network entity, an encrypted quantum safe shared key along with a cipher-text value and a MAC-tag value associated with the subscriber from a user equipment. Further, the method comprises applying, by the network entity, a quantum safe cryptographic technique on the encrypted quantum safe shared key. The method further comprises generating a decrypted quantum safe shared key based on the applied quantum safe cryptographic technique, thereby authenticating the subscriber.

In another non-limiting embodiment of the present disclosure, the method of applying the quantum safe cryptographic technique on the encrypted quantum safe shared key further comprises applying the quantum safe cryptographic technique on a quantum based private key associated with a home network.

In another non-limiting embodiment of the present disclosure, the quantum safe cryptographic technique comprises at least one of Post-quantum cryptography (PQC) technique or Quantum key distribution (QKD) technique.

In another non-limiting embodiment of the present disclosure, the decrypted quantum safe shared key is used for de-concealment of the subscriber's identify while performing the primary authentication of the subscriber.

The present disclosure discloses user equipment (UE) for facilitating post quantum secure primary authentication of a subscriber. The UE comprises a processor and a memory. The processor is configured to apply a quantum safe cryptographic technique on a quantum based public key associated with a home network. Further, the processor is configured to generate a quantum safe shared key and an encrypted quantum safe shared key based on the applied quantum safe cryptographic technique. Finally, the processor is configured to transmit the encrypted quantum safe shared key along with cipher-text value and MAC-tag value associated with the subscriber to a network entity for authenticating the subscriber.

In another non-limiting embodiment of the present disclosure, the quantum safe cryptographic technique comprises at least one of Post-quantum cryptography (PQC) technique or Quantum key distribution (QKD) technique.

In another non-limiting embodiment of the present disclosure, a quantum safe shared key is used for concealing the subscribers identify while initiating the primary authentication of the subscriber.

In another non-limiting embodiment of the present disclosure, the quantum based public key is received by the UE from the home network.

In another non-limiting embodiment of the present disclosure, the present disclosure relates to a network entity for performing secure primary authentication of a subscriber. The network entity comprises a processor and a memory. The processor is configured to receive an encrypted quantum safe shared key along with a cipher-text value and a MAC-tag value associated with the subscriber from a user equipment. Further, the processor is configured to apply a quantum safe cryptographic technique on the encrypted quantum safe shared key and generate a decrypted quantum safe shared key based on the applied quantum safe cryptographic technique, thereby authenticating the subscriber.

In another non-limiting embodiment of the present disclosure, to apply the quantum safe cryptographic technique on the encrypted quantum safe shared key, the processor is further configured to apply the quantum safe cryptographic technique on a quantum based private key associated with a home network.

In another non-limiting embodiment of the present disclosure, the quantum safe cryptographic technique comprises at least one of Post-quantum cryptography (PQC) technique or Quantum key distribution (QKD) technique.

In another non-limiting embodiment of the present disclosure, the decrypted quantum safe shared key is used for de-concealment of the subscriber's identify while performing the primary authentication of the subscriber.

The foregoing summary is illustrative only and is not intended to be in any way limiting. In addition to the illustrative aspects, embodiments, and features described above, further aspects, embodiments, and features will become apparent by reference to the drawings and the following detailed description. For a better understanding of exemplary embodiments of the present invention, together with other and further features and advantages thereof, reference is made to the following description, taken in conjunction with the accompanying drawings.

### DESCRIPTION OF DRAWINGS

The embodiments of the disclosure itself, as well as a preferred mode of use, further objectives, and advantages thereof, will best be understood by reference to the following detailed description of an illustrative embodiment when read in conjunction with the accompanying drawings. Initially, the FIGS. 1-5 describes the existing procedure/technique being followed during the authentication procedure. Whereas one or more embodiments of the present disclosure for secure primary authentication of a subscriber are now described, by way of example only, with reference to the accompanying drawings 6-13:

FIG. 1 shows a flow diagram illustrating a method for initiating authentication procedure from user equipment (UE) to home network (HN), during UE registration request to HN with SUCI as defined in prior art;

FIG. 2 shows a format of SUCI and scheme output as defined in prior art;

FIG. 3 shows a flow diagram of Subscription Permanent Identifier (SUPI) concealment procedure at the UE based on Elliptical Curve based Integrated Encryption Scheme (ECIES) as per prior art;

FIG. 4 shows a flow diagram of SUCI de-concealment procedure at HN based on ECIES as per prior art;

FIG. 5 illustrates a complete sequence flow diagram of SUCI concealment and de-concealment procedure in brief as per prior art;

FIG. 6 discloses environment facilitating secure primary authentication of a subscriber, in accordance with various embodiments of the present disclosure;

FIG. 7A illustrates a block diagram of a User equipment (UE) facilitating secure primary authentication of a subscriber in accordance with various embodiments of the present disclosure;

FIG. 7B illustrates a sequence diagram of user equipment for facilitating secure primary authentication of a subscriber in accordance with various embodiments of the present disclosure;

FIG. 8A illustrates a block diagram of a network entity for performing secure primary authentication of a subscriber in accordance with various embodiments of the present disclosure;

FIG. 8B illustrates a sequence diagram of network entity for performing secure primary authentication of a subscriber in accordance with various embodiments of the present disclosure;

FIG. 9 illustrates a flowchart illustration of a method for facilitating secure primary authentication of a subscriber, in accordance with various embodiments of the present disclosure; and

FIG. 10 illustrates a flowchart illustration of a method for facilitating decrypted quantum safe shared key, in accordance with various embodiments of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### MODE FOR INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

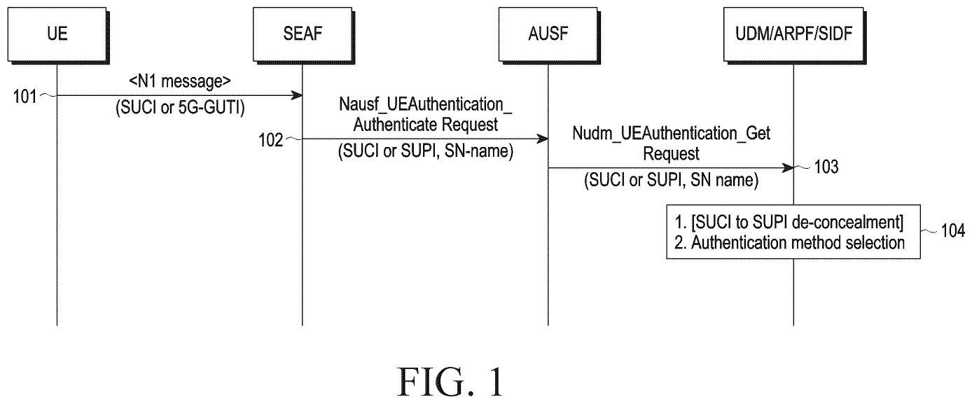

FIG. 1 shows a flow diagram illustrating a method for initiating authentication procedure from UE to HN, during UE registration request to HN with SUCI.

As illustrated in FIG. 1, in step 101, a UE may send a registration request message to the network to initiate authentication procedure (for example, N1 message). Further, the UE may send SUCI in the registration request to Security Anchor Function (SEAF), which reside in serving network.

Subsequently, in step 102, SEAF may send Nausf_UEAuthentication_Authenticate Request message to the Authentication Server Function (AUSF), which reside in Home Network (HN). In step 103, the AUSF may further transfer SUCI to Unified Data Management (UDM) via Nudm_UEAuthentication_Get. Upon reception of Nudm_UEAuthentication_Get Request, in step 104 the UDM may use Subscription Identifier De-concealing Function (SIDF) to de-conceal SUCI to retrieve SUPI. Based on SUPI, the UDM may choose the authentication method.

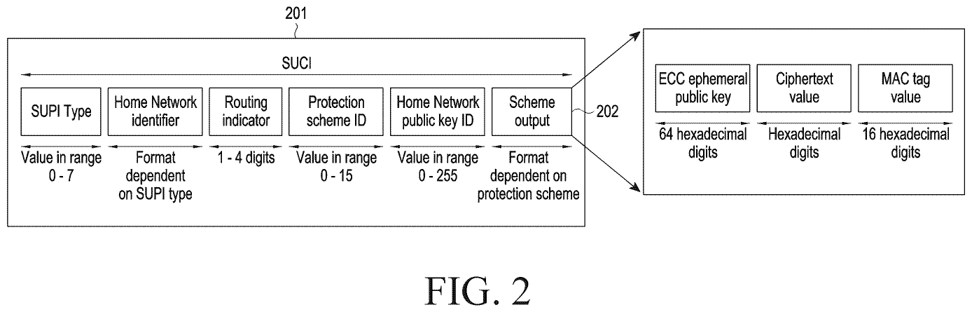

FIG. 2 shows a format of SUCI, and scheme output as defined.

As illustrated in FIG. 2, the SUCI 201 is a privacy preserving identifier containing the concealed SUPI, defined in TS 33.501. The SUCI 201 is composed of at least one of SUPI type, Home Network Identifier (HNI), Routing Indicator (RI), Protection Scheme Identifier (PSI), Home Network Public Key Identifier (HNPKI), or Scheme Output (SO) 202.

The ‘SUPI Type’ is used to identify type of identifier. Value of SUPI type may be between 0-7, for example, in case of type IMSI a value ‘0’ is used and while in case of Network Specific Identifier type, a value ‘1’ is used. The HNI is used to identify the HN of the subscriber. For e.g., in case of SUPI of type IMSI, the HNI is consist of Mobile Country Code (MCC) and Mobile Network Code (MNC). The RI consists of 1 to 4 decimal digits assigned by the HN operator. The PSI consists of a value in the range of 0 to 15, and it is used to specify which encryption profile should be used to conceal the SUPI. The HNPKI is consist of a value in the range 0 to 255, and it represent a public key provisioned by the Home Public Land Mobile Network (HPLMN) or Stand-alone Non-Public Network (SNPN) and it is used to identify the key used for SUPI protection.

The SO 202 may consist of a string of characters with a variable length or hexadecimal digits, and it is dependent on the used protection scheme. For e.g., in case of encryption Profile-A, the SO 202 may be consisting of UE ephemeral (eph.) public key, ciphertext and mac-tag value.

Further, in 5G, the SUPI Concealment and SUCI De-concealment is performed according to Elliptical Curve based Integrated Encryption Scheme (ECIES) at UE and HN, respectively. The ECIES allow UE to encrypt the subscription identifier with the help of elliptical curve-based cryptography, symmetric key cryptography and hashing operation. The ECIES perform the encryption on basis of protection scheme profile. Further, during SIM provisioning HN share a protection scheme profile to the UE. These profiles are defined in TS 33.501. Further, the profiles include various configuration parameter for ECIES scheme. Overall, ECIES allow two party to establish and to exchange secure information over an insecure channel. ECIES scheme consists of five different steps. For example, a Key Generation, a Key Agreement, a Key Derivation, a Symmetric Key Encryption, and a Hash-based Message Authentication Code (HMAC) function.

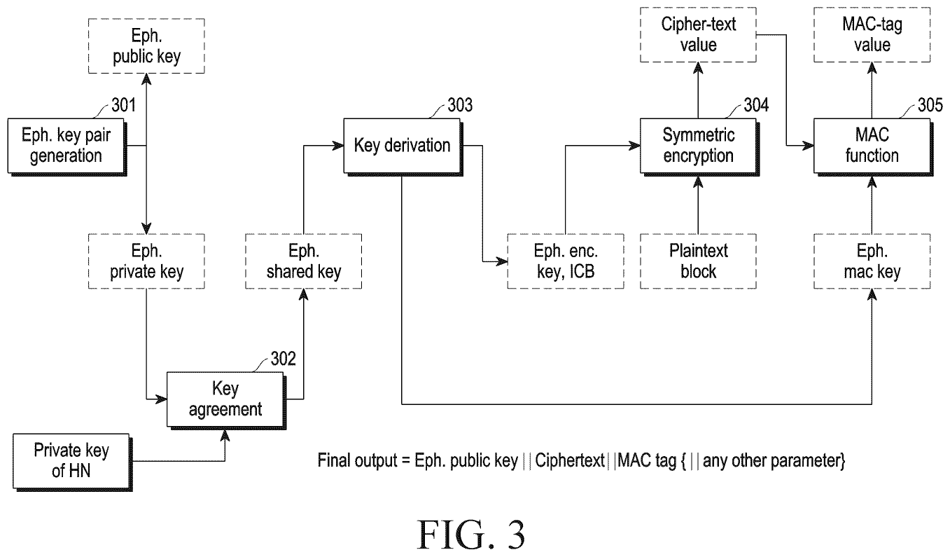

FIG. 3 shows a flow diagram of Subscription Permanent Identifier (SUPI) concealment procedure at the UE based on Elliptical Curve based Integrated Encryption Scheme (ECIES).

As shown in FIG. 3, in step 301, according to the protection scheme profiles, the UE may generate Public/Private key pair using elliptical curve cryptography. In step 302, the UE may use its own ephemeral private key and provisioned HN public key to derive a shared key using Elliptical Curve based Diffie Hellman (ECDH) key agreement operation. The ECDH key agreement allow both parties to derive the same shared key, using each other's public share and own private secret.

In step 303, after generating the shared secret, the UE may use key derivation function to derive multiple keys from the shared key. The Key derivation function, ANSI-X9.63-KDF is used for deriving multiple keys out of shared secret key. In SUPI concealment case, the UE may generate ICB (Initial Control Block), MAC key and Advanced Encryption Standard (AES) encryption key using KDF. In step 304, the UE may finally perform the concealment of SUPI using the symmetric key encryption algorithm, which is Advanced Encryption Algorithm (AES). The AES may generate concealed value of SUPI.

In step 305. The UE may use Hash-based Message Authentication Code (HMAC) function to ensure integrity protection for generated concealed SUPI. The HMAC may generate mac-tag of concealed SUPI using derived mac-key. The aforementioned steps is used for SUPI concealment. Out of these five operations, the key generation and key agreement are based on elliptical curve based public key cryptography. While steps such as key derivation, symmetric key encryption, and the HMAC functions rely on hash functions and symmetric key cryptography. Post concealment of SUPI, the UE send SUCI to HN.

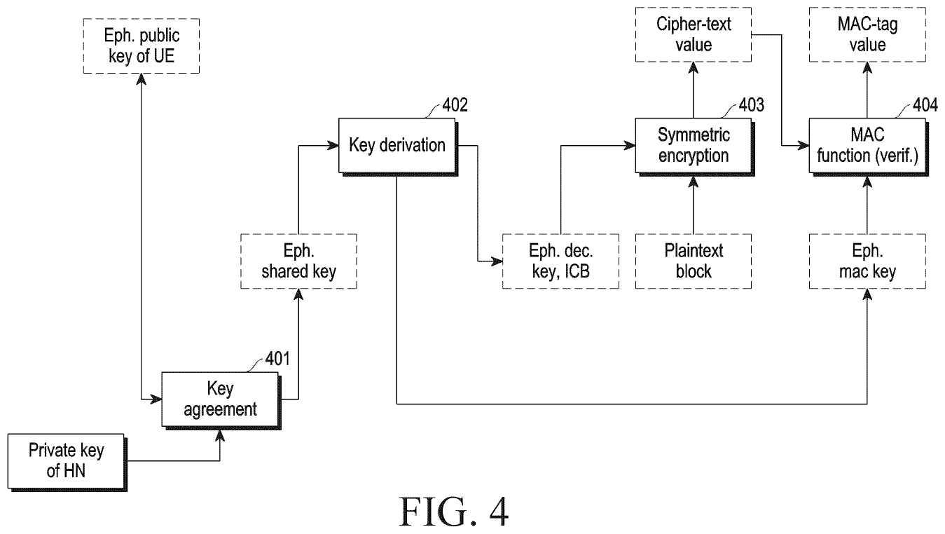

FIG. 4 shows a flow diagram of SUCI de-concealment procedure at HN based on ECIES as per prior art.

As shown in FIG. 4, for SUCI de-concealment, in step 401, the HN may use its private key and the UE ephemeral public key to derive a shared key. Subsequently, similar to SUPI Concealment, in step 402, the HN may use key derivation function to derive multiple keys from shared key. For SUCI de-concealment case, the HN may generate ICB (Initial Control Block), MAC key and AES de-encryption key using KDF. In steps 403 and 404, the HN may perform the de-concealment of SUCI using symmetric key decryption and validate integrity protection using HMAC function. Similar to SUPI concealment, the SUCI de-concealment may also rely on elliptical curve-based cryptography.

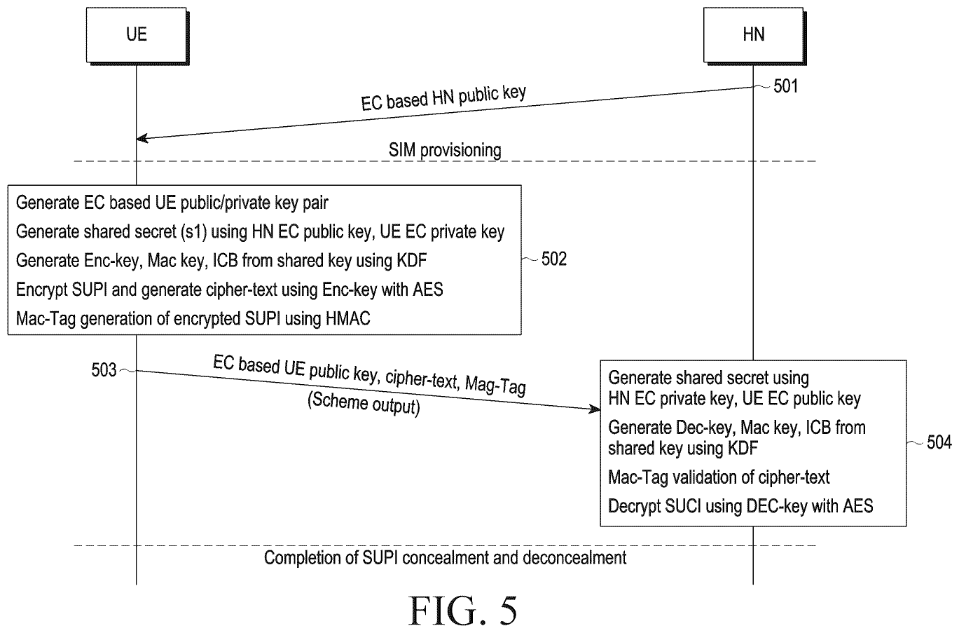

FIG. 5 illustrates a complete sequence flow diagram of SUCI concealment and de-concealment procedure in brief.

As illustrated in FIG. 5, in step 501, the HN may provision the UE with its public key. In step 502, when the UE wants to initiate SUPI concealment, it performs public/private key generation, shared secret, and multiple other key generation. Later, AES encryption and HMAC function may perform encryption of SUPI and mac-tag generation. These all steps are the part of SUPI concealment. After completion of SUPI concealment, the UE may create the Scheme Output, which includes UE Public Key, Cipher-text, and Mac-Tag. Here cipher-text consist concealed SUPI and mac-tag consist mac of concealed SUPI.

In step 503, the Scheme output may be transferred from the UE to the HN as a part of SUCI packet. Post receiving the SUCI, in step 504, the HN may initiate SUCI de-concealment procedure. Further, HN generates shared secret using key agreement and multiple key generation using KDF. Later, HN validate integrity of concealed SUPI using HMAC function and finish SUCI de-concealment using AES decryption function. Both, SUPI concealment and SUCI de-concealment relies on elliptical curve-based cryptography.

It is clear from the above FIGS. 1 to 5 that the SUPI concealment and de-concealment depends on elliptical curve-based algorithm (ECIES) for Primary Authentication. However, the elliptical curve-based algorithm used for primary authentication is prone to quantum attacks. In other words, any quantum machine can break algorithm based on logarithmic hard problem of the ECIES. Thus, the objective of the present disclosure is to secure SUPI concealment and de-concealment.

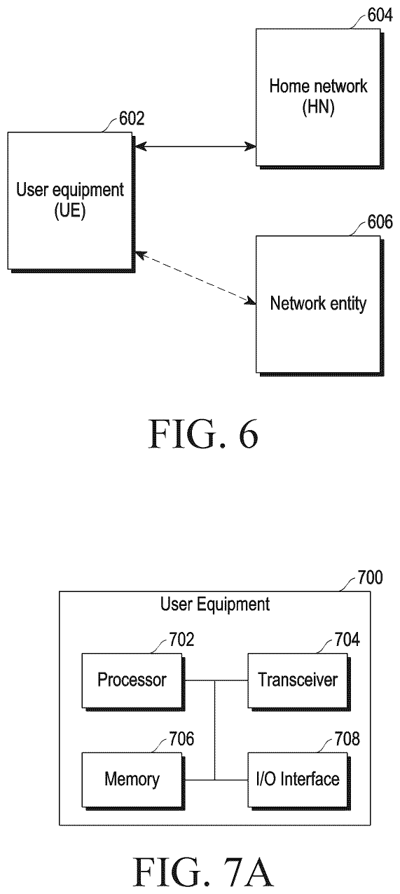

FIG. 6 discloses an environment facilitating post quantum secure primary authentication of a subscriber.

Referring to FIG. 6, the environment includes User Equipment (UE) 602, home network (HN) 604 and the network entity 606. The present disclosure defines the mechanism for SUPI to SUCI concealment and de-concealment procedure based on post quantum cryptography technique. The present disclosure also defines the mechanism for key generation, and procedures between UE and HM which is based on Post-quantum cryptography (PQC). For providing the secure authentication (as described above), the present disclosure achieves mutual authentication between the UE and the network (operator's network). The UE 602 and the home network 604, the serving network entity 606 may authenticate the SUPI of the UE 602 and the UE 602 may in turn authenticate the serving network identifier through implicit key authentication. For 3GPP access as described in the above background section, the SUPI is based on IMSI in and for non-3GPP access, the SUPI is based on Network Access Identifier (NAI).

In the present disclosure, a public key of the HN is used by the PQC techniques to generate a random number. In other words, when the quantum safe cryptographic technique is applied on a quantum based public key associated with HN, the UE may generate a quantum safe shared key and an encrypted quantum safe shared key based on the applied quantum safe cryptographic technique. For ease of understanding, the UE may need not generate any public key and private key which further requires public key of the home network to generate the safe shared key. The present disclosure eliminates the process where the usage of public and private key of UE is used. However, the public key of the HN is used based on which the quantum safe cryptographic technique is applied to generate a quantum safe shared key and the encrypted quantum safe shared key. The encrypted quantum safe shared key that is generated is shared along with the cipher-text value and MAC-tag value associated with the subscriber to a network entity for authenticating the subscriber.

The network entity applies a quantum safe cryptographic technique on the encrypted quantum safe shared key and generate decrypt quantum safe shared key based on the applied quantum safe cryptographic technique, thereby authenticating the subscriber. In other words, the new mechanism that can be used for key encapsulation and de-encapsulation which is required for key generation and encryption and decryption of any identifier like SUPI or any other equivalent identifier between UE and network.

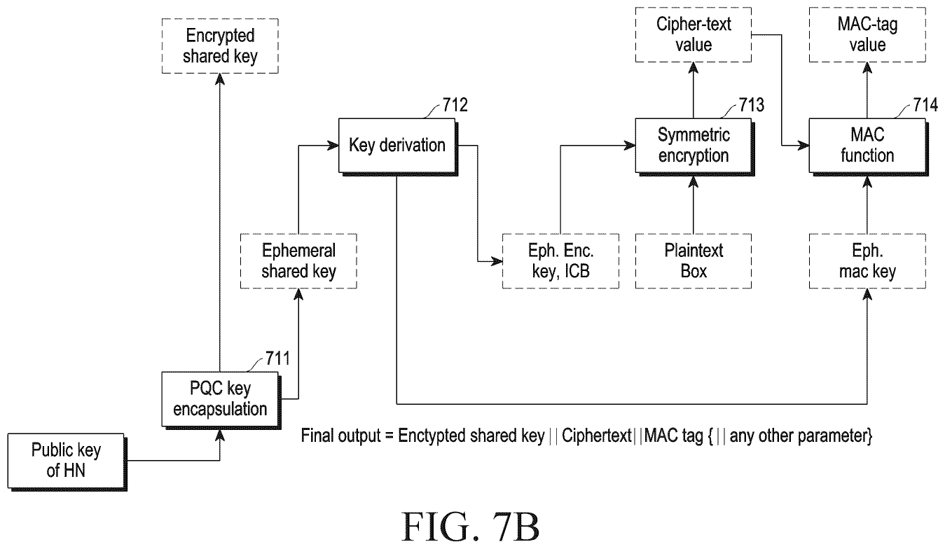

FIG. 7A illustrates a block diagram of a User equipment (UE) facilitating post quantum secure primary authentication of a subscriber in accordance with various embodiments of the present disclosure.

Referring to FIG. 7A, the UE 700 (e.g., the UE 602) may comprise various hardware components such as a processor 702, a transceiver 704, a memory 706 and an I/O interface 708 but not limited thereto. The processor 702, the memory 706 and the I/O interface 708, may be communicatively coupled to each other via wired or wireless communication channels.

The processor 702 may be configured to execute instructions stored in the memory and to perform various processes. The I/O interface 708 may be configured for coupling the internal hardware components and with external devices via one or more networks. The memory 706 may also store instructions to be executed by the processor 702. The memory may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The Memory may also store data processed by the processor 702 and the Network Slice Admission Controller and obtained via I/O interface 708.

In an embodiment, initially the processor 702 may apply a quantum safe cryptographic technique on a quantum based public key associated with a home network. The quantum safe cryptographic technique comprises, but not limited to, a Post-quantum cryptography (PQC) technique or a Quantum key distribution (QKD) technique. In other words, the processor applies PQC technique on public key of the home network in order to generate a quantum safe shared key and the encrypted safe shared key. A quantum safe shared key is used for concealing the subscriber's identity while initiating the primary authentication of the subscriber. In other words, to facilitate secure primary authentication of a subscriber, in the present disclosure, the PQC based key encapsulation method may be used to generate shared key.

In the PQC technique, the processor 702 is configured to receive HN public key as input and generate the encrypted quantum safe shared key (particularly two output which may include shared key and encrypted shared key). The generated encrypted quantum safe shared key is further used in for key derivation in step 712 as shown in FIG. 7B.

FIG. 7B illustrates a sequence diagram for facilitating secure primary authentication of a subscriber in accordance with various embodiments of the present disclosure. In this step, the UE 700 or the processor 702 may receive shared key as input and may generate multiple keys such as MAC key and AES encryption key. The processor 702 may use symmetric key encryption to conceal SUPI. The processor 702 may use predefined function such as Hash-based message authentication code (HMAC) function to derive MAC tag corresponding to encrypt SUPI, which is required to provide integrity. Upon SUPI concealment at the UE 700, the Scheme Output may be sent to the HN. Generally, the Scheme Output may include encrypted SUPI (encrypted quantum safe shared key) and other parameters that are required for smooth de-concealment of SUCI at HN end.

Step 711 of FIG. 7B discloses receiving the public key of the home network as the input. The PQC techniques are applied to the public key of the HN.

Based on the applied PQC technique on the input, which is the public key of the HN, the outputs such as shared key and encrypted shared key may be generated as disclosed in the sequence diagram of FIG. 7B.

The generated shared key further used in for key derivation as disclosed in step 712. In this step, the UE may receive shared key as input and may generate multiple keys such as key and AES encryption key.

The UE may use symmetric key encryption to conceal the encrypted quantum safe shared key (SUPI) as disclosed step 713. The UE may use HMAC function to derive MAC tag corresponding to encrypted SUPI, which is required to provide integrity as disclosed in step 714.

Finally, the encrypted quantum safe shared key along with cipher-text value and MAC-tag value associated with the subscriber is transmitted to a network entity for authenticating the subscriber.

Although FIG. 7A shows various hardware components of the UE, but it is to be understood that other embodiments are not limited thereon. In other embodiments, the UE may include a lesser or greater number of components. Further, the labels or names of the components are used only for illustrative purposes and does not limit the scope of the disclosure. One or more components can be combined together to perform same or substantially similar function in the UE.

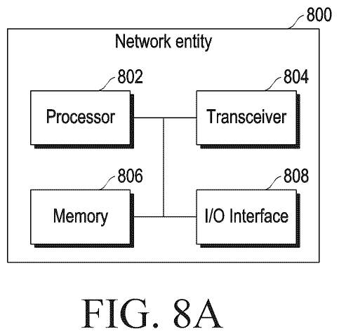

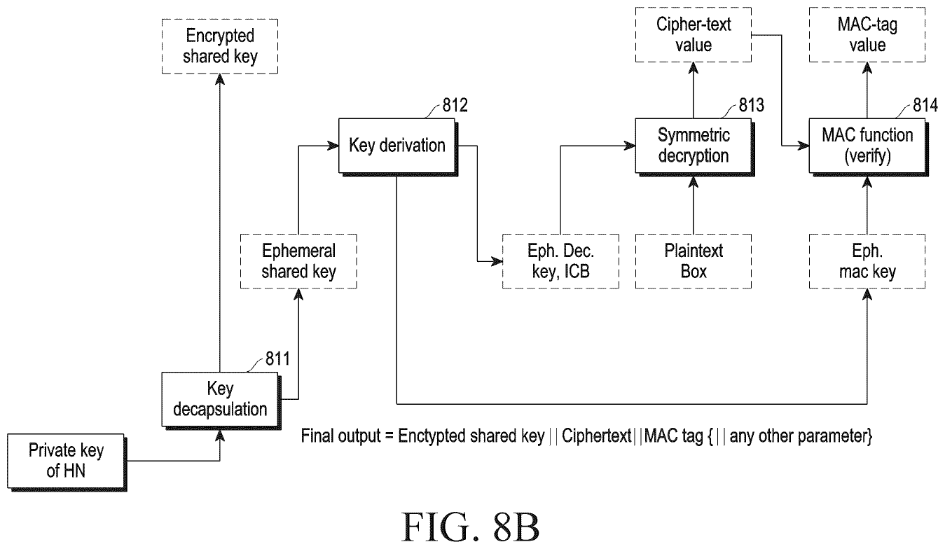

FIG. 8A illustrates a block diagram of a network entity for performing secure primary authentication of a subscriber in accordance with various embodiments of the present disclosure. The network node 800 (e.g., the network entity 606) may comprise various hardware components such as a processor/processing unit 802, transceiver 804, memory 806 and I/O interface 808 but not limited thereto. The processing unit 802 may be communicatively coupled to the transceiver 804 via wired or wireless communication channels. Further, the processing unit 802 may be configured to execute instructions stored in the memory 806 and to perform various processes.

FIG. 8B illustrates a sequence diagram of network entity for performing secure primary authentication of the subscriber in accordance with various embodiments of the present disclosure. Firstly, the processor 802 may receive the encrypted quantum safe shared key along with cipher-text value and MAC-tag value associated with the subscriber from the UE. Once it is received, the processor 802 may apply a quantum safe cryptographic technique on the encrypted quantum safe shared key and generates a decrypted quantum safe shared key based on the applied quantum safe cryptographic technique, thereby authenticating the subscriber.

During the process of decrypting the quantum safe shared key, the processor 802 may consider HN private key and an encrypted quantum safe shared key as an input and generate decrypted quantum safe shared key as output. Thus, the above FIGS. 7A, 7B, 8A, and 8B describe SUPI concealment and de-concealment respectively, and also to make use of encrypted quantum safe shared key as input and may generate multiple keys such as cipher text value, MAC tag value.

Step 811 of FIG. 8B describes that the quantum safe cryptographic technique may be applied on the encrypted quantum safe shared key. In other words, the HN may use PQC techniques, which take HN private key and the encrypted quantum safe shared key as an input and generate decrypted quantum safe shared key as output. Here, by using PQC de-capsulation method at HN instead of using ECDH based key agreement for shared key generation.

At step 812, the generated shared key may be used in key derivation. In step 812, the shared key may be used as the input and may generate multiple keys similar to SUPI concealment.

At step 813, the HN may use symmetric key decryption to de-conceal SUCI and validate integrity of the received SUCI using HMAC function.

At step 814, the decrypted quantum safe shared key along with cipher-text value and MAC-tag value associated with the subscriber may be used for authenticating the subscriber.

The present disclosure describes PQC techniques that provides different procedures for quantum safe shared key exchanges. The procedures may include PQC based Key Generation, Key Encapsulation, Decapsulation and the like. The PQC based key generation procedure helps to generates public and private key pair. These PQC based procedures may utilize to make SUPI concealment and de-concealment secure.

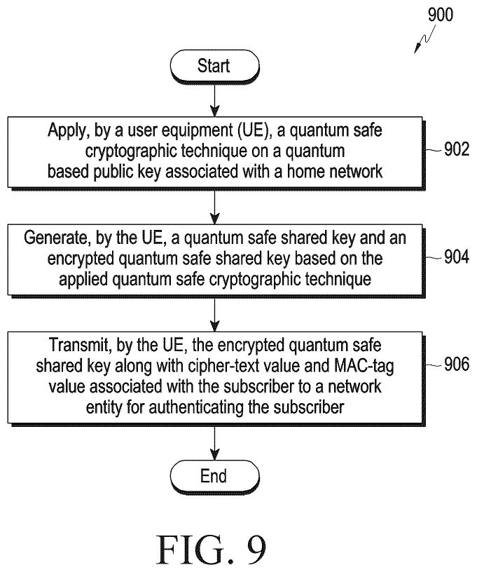

FIG. 9 illustrates a flowchart illustration of a method for facilitating secure primary authentication of a subscriber, in accordance with some embodiments of the present disclosure.

As illustrated in FIG. 9, method 900 includes one or more blocks illustrating a method of facilitating secure primary authentication of a subscriber. The method 900 may be described in the general context of computer executable instructions. Generally, computer executable instructions can include routines, programs, objects, components, data structures, procedures, modules, and functions, which perform functions or implement abstract data types.

The order in which the method 900 is described is not intended to be construed as a limitation, and any number of the described method blocks can be combined in any order to implement the method 900. Additionally, individual blocks may be deleted from the methods without departing from the spirit and scope of the subject matter described herein. Furthermore, the method 900 can be implemented in any suitable hardware, software, firmware, or combination thereof.

At block 902, the method 900 may include applying, by a user equipment (UE), a quantum safe cryptographic technique on a quantum based public key associated with a home network. The quantum safe cryptographic technique comprises at least one of Post-quantum cryptography (PQC) technique or Quantum key distribution (QKD) technique.

At block 904, the method 900 may include generating, by the UE, a quantum safe shared key and an encrypted quantum safe shared key based on the applied quantum safe cryptographic technique.

At block 906, the method 900 may include transmitting, by the UE, the encrypted quantum safe shared key along with cipher-text value and MAC-tag value associated with the subscriber to a network entity for authenticating the subscriber.

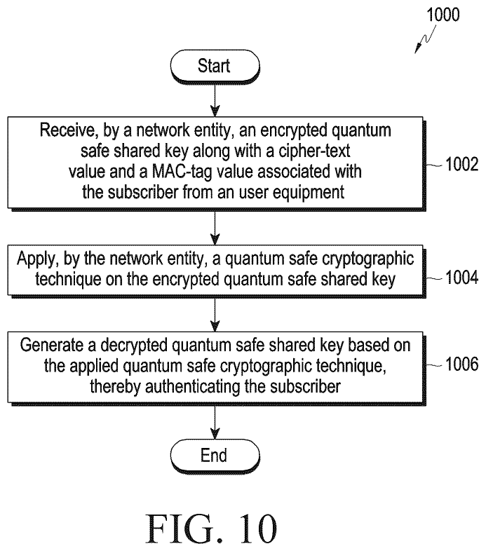

As illustrated in FIG. 10, method 1000 includes one or more blocks illustrating a method of performing secure primary authentication of a subscriber. The method 900 may be described in the general context of computer executable instructions. Generally, computer executable instructions can include routines, programs, objects, components, data structures, procedures, modules, and functions, which perform functions or implement abstract data types.

The order in which the method 1000 is described is not intended to be construed as a limitation, and any number of the described method blocks can be combined in any order to implement the method 1000. Additionally, individual blocks may be deleted from the methods without departing from the spirit and scope of the subject matter described herein. Furthermore, the method 1000 can be implemented in any suitable hardware, software, firmware, or combination thereof.

At block 1002, the method 1002 may include receiving, by a network entity, an encrypted quantum safe shared key along with a cipher-text value and a MAC-tag value associated with the subscriber from a user equipment. the quantum safe cryptographic technique comprises at least one of Post-quantum cryptography (PQC) technique or Quantum key distribution (QKD) technique.

At block 1004, the method 10004 may include applying, by the network entity, a quantum safe cryptographic technique on the encrypted quantum safe shared key.

At block 1006, the method 1006 may include generating a decrypted quantum safe shared key based on the applied quantum safe cryptographic technique, thereby authenticating the subscriber.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the detailed description.

The order in which the various operations of the methods are described is not intended to be construed as a limitation, and any number of the method described blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

It may be noted here that the subject matter of some or all embodiments described with reference to FIGS. 1-8 may be relevant for the methods and the same is not repeated for the sake of brevity.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise. The terms “including”, “comprising”, “having” and variations thereof, when used in a claim, is used in a non-exclusive sense that is not intended to exclude the presence of other elements or steps in a claimed structure or method, unless expressly specified otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present disclosure are intended to be illustrative, but not limiting, of the scope of the invention, which is set forth in the appended claims.

1. A method performed by a user equipment (UE) for performing secure primary authentication of a subscriber, the method comprising:
applying a quantum safe cryptographic technique on a quantum based public key associated with a home network;
generating a quantum safe shared key and an encrypted quantum safe shared key based on the applied quantum safe cryptographic technique; and
transmitting, to a network entity, the encrypted quantum safe shared key along with a cipher-text value and message authentication code (MAC)-tag value associated with the subscriber for authenticating the subscriber.

2. The method of claim 1, wherein the quantum safe cryptographic technique comprises at least one of post-quantum cryptography (PQC) technique or quantum key distribution (QKD) technique.

3. The method of claim 1, wherein the quantum safe shared key is used for concealing the subscriber's identification while performing the secure primary authentication of the subscriber.

4. The method of claim 1, wherein the quantum based public key is received by the UE from the home network.

5. A method performed by a network entity for performing secure primary authentication of a subscriber, the method comprising:
receiving, from a user equipment (UE), an encrypted quantum safe shared key along with a cipher-text value and a message authentication code (MAC)-tag value associated with the subscriber;
applying a quantum safe cryptographic technique on the encrypted quantum safe shared key; and
generating a decrypted quantum safe shared key for authenticating the subscriber, based on the applied quantum safe cryptographic technique.

6. The method of claim 5, wherein applying the quantum safe cryptographic technique on the encrypted quantum safe shared key further comprises:
applying the quantum safe cryptographic technique on a quantum based private key associated with a home network.

7. The method of claim 5, wherein the quantum safe cryptographic technique comprises at least one of post-quantum cryptography (PQC) technique or quantum key distribution (QKD) technique.

8. The method of claim 5, wherein the decrypted quantum safe shared key is used for de-concealment of the subscriber's identification while performing the secure primary authentication of the subscriber.

9. A user equipment (UE) for performing secure primary authentication of a subscriber, the UE comprising:
a transceiver;
memory;
at least one processor coupled to the transceiver, and configured to:
apply a quantum safe cryptographic technique on a quantum based public key associated with a home network;
generate a quantum safe shared key and encrypted quantum safe shared key based on the applied quantum safe cryptographic technique; and
transmit, to a network entity, the encrypted quantum safe shared key along with a cipher-text value and message authentication code (MAC)-tag value associated with the subscriber for authenticating the subscriber.

10. The UE of claim 9, wherein the quantum safe cryptographic technique comprises at least one of post-quantum cryptography (PQC) technique or quantum key distribution (QKD) technique.

11. The UE of claim 9, wherein the quantum safe shared key is used for concealing the subscriber's identification while performing the secure primary authentication of the subscriber.

12. The UE of claim 9, wherein the quantum based public key is received by the UE from the home network.

13. A network entity for performing secure primary authentication of a subscriber, the network entity comprising:
a transceiver;
memory;
at least one processor coupled to the transceiver, and configured to:
receive, from a user equipment (UE), an encrypted quantum safe shared key along with a cipher-text value and a message authentication code (MAC)-tag value associated with the subscriber;
apply a quantum safe cryptographic technique on the encrypted quantum safe shared key; and
generate a decrypted quantum safe shared key for authenticating the subscriber, based on the applied quantum safe cryptographic technique.

14. The network entity of claim 13, wherein to apply the quantum safe cryptographic technique on the encrypted quantum safe shared key, the processor is further configured to:
apply the quantum safe cryptographic technique on a quantum based private key associated with a home network.

15. The network entity of claim 13, wherein the quantum safe cryptographic technique comprises at least one of post-quantum cryptography (PQC) technique or quantum key distribution (QKD) technique.

16. The network entity of claim 13, wherein the decrypted quantum safe shared key is used for de-concealment of the subscriber's identification while performing the secure primary authentication of the subscriber.

17. The method of claim 1, wherein the encrypted quantum safe shared key comprises subscription permanent identifier (SUPI).

18. The method of claim 5, wherein the encrypted quantum safe shared key comprises subscription permanent identifier (SUPI).

19. The UE of claim 9, wherein the encrypted quantum safe shared key comprises subscription permanent identifier (SUPI).

20. The network entity of claim 13, wherein the encrypted quantum safe shared key comprises subscription permanent identifier (SUPI).
